(19) United States
(12) Patent Application Publication
(10) Pub. No.: US 2025/0163650 A1
(43) Pub. Date: May 22, 2025

(54) METHOD FOR REWETTING A WEB MADE FROM PAPER, AND PLANT

(71) Applicant: BHS Corrugated Maschinen- und Anlagenbau GmbH, Weiherhammer (DE)

(72) Inventors: Julian Messer, Pfreimd (DE); Tim Slawik, Bayreuth (DE)

(21) Appl. No.: 18/875,705

(22) PCT Filed: Mar. 1, 2024
(86) PCT No.: PCT/EP2024/055449

§ 371 Date: Dec. 16, 2024

(30) Foreign Application Priority Data
Mar. 6, 2023 (DE) 10 2023 201 978.7

(51) Int. Cl. D21H 25/00

(52) U.S. Cl. CPC D21H 25/00

(57) ABSTRACT

A method is specified for rewetting a web (4) made from paper, wherein the web (4) is guided through a plant (2), wherein the plant (2) comprises a processing unit (10), by way of which the web (4) is processed, wherein, downstream of the processing unit (10), the plant (2) comprises a drying unit (12), for drying the web (4), wherein, downstream of the drying unit (12), the plant (2) comprises a plurality of wetting units (18, 20), by means of which the web (4) is rewetted in multiple stages using a wetting agent, pre-wetting of the web (4) taking place by way of a first one of the wetting units (18), and post-wetting of the web (4) taking place after a minimum dwell time (T) by way of a second one of the wetting units (20), wherein the minimum dwell time (T) is selected in such a way that the web (4) has an increased absorption rate for the wetting agent in the second wetting unit (20) on account of the pre-wetting. Furthermore, a plant (2) is specified for processing a web (4) made from paper.

The invention relates to a method for rewetting a web made from paper, and to a plant for processing a web made from paper.

Examples of plants for processing webs made from paper are printing machines for printing on such a web and corrugated cardboard plants for producing a web (more specifically a corrugated cardboard web) that is composed of a plurality of individual layers made from paper.

In the context of the processing of a web made from paper, the web is commonly dried, for example after a printing process in a printing machine. A significant amount of moisture (i.e. water) is removed from the paper during the drying process, which moisture is then expediently added back to the paper later as part of a rewetting process. A problem here is however that the paper has only a limited absorption capacity for water that is applied to the web during the rewetting process. Under certain circumstances, therefore, not all of the moisture previously removed can be added back. This then often leads to defects, such as wrinkling, the tin can effect, roping and the like. Such defects are in turn problematic when the web is wound up at the end of the plant or when the web is directly transferred to a downstream plant in inline operation.

U.S. Pat. No. 5,596,930 A describes a method for wetting a moving web of printed material. Here, a wetting agent may be applied to the web in a plurality of steps.

Against this background, it is an object of the invention to improve the rewetting of a web made from paper. In particular, it is sought to specify a correspondingly improved method and an improved plant for this purpose.

The object is achieved according to the invention by a method having the features according to claim 1 and by a plant having the features according to claim 15. The dependent claims relate to advantageous embodiments, further developments, and variants. The statements in connection with the method also apply analogously to the plant, and vice versa. If steps of the method are specified below, advantageous embodiments of the plant result from the fact that the plant is designed to carry out one or more of these steps.

A core concept of the present invention is in particular multi-stage rewetting, in which a process of rewetting of a web made from paper is divided into a plurality of stages, in each of which a wetting agent is applied to the web. This makes it possible to utilize the effect that a web that has been pre-wetted subsequently absorbs further moisture much better than a web that has not been pre-wetted, such that it is possible to introduce significantly more wetting agent, specifically water, and thus moisture into the paper.

The method according to the invention serves for rewetting a web made from paper and is in particular also an operating method for a plant in which the rewetting is performed. In the following, without any loss of generality, a single-layer web made from paper, that is to say a web made from paper in the narrower sense, is assumed, but the invention is also applicable to other and in particular multi-layer webs made from paper, for example a corrugated cardboard web or a precursor for such a web, which is then composed of a plurality of individual layers made from paper.

The web is guided through a plant. For example, the web is unrolled by an unwinder of the plant, then processed, and finally rolled up again by a winder of the plant, or alternatively passed on directly to a downstream plant. In the following, without any loss of generality, it is assumed that the plant is a printing machine, but the statements made here apply generally to any plant which processes a web made from paper and which performs rewetting in this context. A particularly advantageous embodiment is, for example, one in which the plant is a corrugated cardboard plant for producing corrugated cardboard.

The plant generally has a processing unit by which the web is processed. Furthermore, downstream of the processing unit, the plant has a drying unit for drying the web (i.e. the processed web). For drying purposes, the drying unit has in particular one or more hot-air dryers and/or infrared dryers. The nature of the processing and of the drying are not of primary relevance; what is more important is that, as a matter of principle, moisture is removed from the paper during the drying process. It is intended that, as part of the method, this moisture is added back as completely as possible by way of a rewetting process. For this purpose, downstream of the drying unit, the plant comprises a plurality of wetting units, by means of which the web (i.e. the dried web) is rewetted in multiple stages using a wetting agent. Accordingly, the wetting units are used to add moisture back to the web after the drying process, by virtue of a wetting agent being applied to the web. In this case, the web is rewetted with the wetting agent in a plurality of stages by virtue of the web being pre-wetted (also referred to as initial wetting) by a first of the wetting units and being post-wetted (also referred to as secondary wetting), after a minimum dwell time, by a second of the wetting units. The pre- and post-wetting are performed in particular on the same side of the web, and in an expedient embodiment even on both sides.

The wetting agent contains in particular water, preferably predominantly (i.e. ≥95% or even ≥99%) water, or is even exclusively water. The water is suitably as soft and/or desalinated as possible. In a particularly advantageous embodiment, the wetting agent is a mixture of water and a wetting additive, preferably in a proportion of at most 1 vol. %, particularly preferably of at most 0.1 vol. %, which in the case of high-quality wetting additives is generally sufficient to achieve a minimum surface tension. The wetting additive serves to reduce the surface tension of the water (for example from 72.7 mN/m (polar fraction: 51 mN/m, disperse fraction: 21.7 mN/m) at 20° C. to 28.5 mN/m (polar fraction: 5.2 mN/m, disperse fraction: 23.3 mN/m)), and thus further increases the absorption rate. Optionally, the wetting agent is additionally mixed with air or another inert gas (for example nitrogen).

In the present case, “A is upstream of B” and equivalently “B is downstream of A” is understood to mean that A is situated ahead of B along the path, that is to say the path passes firstly through A and then through B. Instead of “upstream/downstream”, the term pairs “in front of/behind” and “before/after” are also used.

For the sake of simplicity, reference will be made here to “the web” being treated (processed, dried, wetted, etc.). This means in particular that the web undergoes the corresponding treatment gradually in sections, that is to say it is not firstly processed in its entirety, then dried in its entirety and only then wetted; rather, the web is guided continuously (i.e. inline) through the entire plant, with each section of the web being treated at a particular point and then passed on directly.

The minimum dwell time is selected in such a way that the web has an increased absorption rate for the wetting agent in the second wetting unit on account of the pre-wetting (by the first wetting unit). In a suitable, but not mandatory, embodiment, this is understood to mean an absorption rate in the range from 0.1 s to 1 s, in particular for an amount of 3 g/m² of wetting agent (i.e. then 3 to 30 g/(s*m²)) and a corresponding absorption rate for other amounts. In other words, by way of the pre-wetting, wetting agent is applied to the web and is absorbed into the paper during the minimum dwell time, such that the web has increased hydrophilicity after the minimum dwell time. This utilizes the knowledge that, during the pre-wetting process, the wetting agent initially forms a liquid film on the web, which liquid film, owing to the preceding drying process, is not immediately completely absorbed into the paper but at least partially remains in situ, and in any case requires a certain amount of time to be completely absorbed by the paper. During this time, the web is flooded with the wetting agent, so to speak, and a further supply of wetting agent is pointless because it cannot be absorbed into the paper. The liquid film forms a corresponding barrier and limits the maximum absorption capacity of the paper. This maximum absorption capacity is also limited by the conveyance of the web through the plant and the available distance, because as soon as the web is to be further processed or wound up, there must be no excess wetting agent left on the web; any such excess must be skimmed off if necessary.

Accordingly, in the present case, the rewetting process is divided into a plurality of stages, specifically is divided among at least two wetting units, which then correspondingly form a first and a second stage of the rewetting process. The pre-wetting process is carried out here not with the actual target amount of wetting agent, but with a reduced amount of wetting agent in relation thereto. Additional wetting agent is then only added during the post-wetting process by the second wetting unit. Here, however, because the web has been pre-wetted, the wetting agent from the second wetting unit is absorbed into the paper much faster than without pre-wetting (i.e. the absorption rate is increased), such that, in total and over the same distance, more wetting agent can be introduced into the web than with only single-stage rewetting. This advantage also applies analogously to a rewetting process with more than two stages.

The minimum dwell time serves in particular for implementing a delay until the most favorable time possible for the post-wetting process. As already indicated, the wetting agent initially forms a liquid film on the web during the pre-wetting process, which liquid film should have been depleted to the greatest possible extent when the web reaches the second wetting unit. As long as a liquid film is present on the web, the absorption rate for further applied wetting agent is practically zero, said absorption rate increasing only once the liquid film has been absorbed by the web. Therefore, the minimum dwell time is preferably selected such that the wetting agent applied by the first wetting unit has been completely absorbed into the web when the web reaches the second wetting unit. It is particularly in this state and at this time that an absorption rate is increased. In principle, it is also possible to simply skim off any liquid film, for example using a squeegee, but in this case any wetting agent that has already been applied is correspondingly discarded and remains unused.

The rate at which the wetting agent is absorbed into the paper is strongly dependent on the initial moisture content (i.e. the initial wetness) of the paper. Dried paper, as is present downstream of the drying unit, absorbs water more slowly than pre-wetted paper. The reason for this is that the hydrophilicity is increased by the water molecules adsorbed on the capillary walls of the paper. This reduces the contact angle and thus increases the absorption speed. This relationship is also summarized in the so-called Lucas-Washburn equation (also referred to simply as Washburn equation). Accordingly, a smaller contact angle results in a higher penetration depth per unit of time, and thus an increased absorption rate. Equivalent to an increased absorption rate are in particular an increased penetration depth, increased hydrophilicity, a reduced contact angle and reduced surface tension.

A particularly problematic factor for the absorption rate of the web is the so-called hornification of the paper. The paper contains paper fibers, which absorb moisture and release said moisture again during a drying process. Hornification is understood to mean any fiber change (i.e. actual change in the paper fibers) that occurs during drying and rewetting processes. Examples of such fiber changes are irreversible pore closure (reduction of the specific surface area) as a result of the formation of hydrogen bonds between neighboring cell walls or a merging of microfibrils. In particular, hornification is irreversible. Hornification commonly occurs during the drying process in the drying unit. Starting from hornified paper, a renewed supply of moisture is particularly difficult, that is to say the absorption rate is particularly low. In particular, the method presented here does not now attempt to introduce as much moisture as possible within a given time and over a given distance using only a single wetting unit, but instead preferably seeks to initially establish an increased absorption rate in a first stage by means of the pre-wetting process. Only when the absorption rate has been significantly increased, ideally when a suitable threshold value for the absorption rate (for example from the range already mentioned above) has been reached, is further moisture introduced into the paper in a second stage by means of the post-wetting process, but this time much more efficiently than in the case of hornified paper, such that overall more moisture is introduced into the paper in the same period of time and over the same distance. Owing to the multi-stage rewetting process and the higher moisture content of the paper that is thus possible, hornification of the paper in the plant is then advantageously even reduced or avoided entirely, particularly during a drying process after the rewetting process, or a drying process between the two stages of the rewetting process.

As a result, it is advantageously thus possible to introduce significantly more wetting agent, specifically water, into the web, which means that a particularly high moisture content can correspondingly be achieved. Analogously, a particularly large loss of moisture during the drying process can be advantageously completely compensated or, if necessary, even overcompensated. This correspondingly reduces or completely prevents defects, such as roping, wrinkling and the tin can effect, during the conveying and processing of the web in the plant. What is particularly relevant here is the wrinkle-free nature of the web, which is ensured by the multi-stage rewetting process, in particular both within the plant and at the end of the plant. In addition, the multi-stage rewetting process has a positive effect on the web shrinkage in the plant, in particular by virtue of the fact that the web shrinkage effect resulting from the drying process is significantly reduced by the subsequent rewetting process. In addition, with the multi-stage rewetting process, it is possible to achieve a difference in the transverse moisture profile of less than 2%, in particular at most 1.3%, that is to say the difference in moisture between any two points along the width of the web is less than 2% or at most 1.3%. If the difference exceeds 2%, a so-called warp commonly occurs during the further processing of the web in a corrugated cardboard plant, that is to say the corrugated cardboard web distorts. Finally, the multi-stage rewetting process also allows a high level of machine dynamics for the plant, specifically with regard to a change in the web speed and a job changeover, because shrinkage of the web is compensated as required at a suitable point. This can be demonstrated in particular by means of suitable sensors for measuring the width of the web in the plant, and is also reflected, in the case of further processing in a corrugated cardboard plant, in a precisely cut blank at the end of said plant.

The minimum dwell time is preferably in the range from 0.5 s to 30 s, particularly preferably in the range from 1 s to 30 s, although the upper limit of 30 s is basically superfluous, that is to say the minimum dwell time is preferably at least 0.5 s or at least 1 s. Tests have shown that such a minimum dwell time is sufficient to achieve the described effect. The minimum dwell time is equivalent to a minimum distance that the web travels between the first and the second wetting unit. The conversion between minimum dwell time and minimum distance is performed using the web speed, that is to say the speed at which the web is conveyed through the plant. The web speed may vary according to the job. At preferred web speeds of 100 m/min to 450 m/min, the aforementioned range from 0.5 s to 30 s nominally results in a minimum distance in the range from 1 m to 225 m; in any case, a minimum distance of at least 2 m is advantageous. The minimum distance is in particular at most significantly less than 225 m, because typically the web run (i.e. the distance that the web covers) through the entire plant is significantly less than 200 m. A minimum distance between the first and the second wetting unit in the range from 25 m to 50 m, in particular 35 m to 40 m, is particularly preferred. These ranges advantageously still lie entirely within the plant. This then results in a minimum dwell time of approximately 4 s to 30 s or 5 s to 24 s for the aforementioned web speeds.

The minimum dwell time between the first and second wetting stage is preferably selected for a maximum web speed (for example 450 m/min) of the plant. Lower web speeds then typically do not pose a problem, because a longer dwell time does not result in a significant change in the moisture content of the paper. Accordingly, there is initially no upper limit for the minimum dwell time; what is primarily relevant is that the web is still moist, and in any case has not completely dried, when it reaches the second wetting unit, resulting in an increased absorption rate for the post-wetting process. Irrespective of this, the amount of wetting agent applied is expediently adjusted as a function of the web speed in such a way that, with varying web speed, always the same amount of wetting agent is applied per unit of time and per unit of area.

The amount of moisture that the paper can absorb typically depends on the grammage (for example in the range from 100 g/m² to 300 g/m² or even higher) of the paper, and generally also on the type of paper. The higher the grammage, that is to say the heavier the paper, the more moisture the paper can absorb. In addition, paper with a higher grammage (in particular >300 g/m²) is typically dried out less strongly (when considering the moisture content in %), such that a high degree of rewetting corresponding to the high grammage is generally not necessary; nevertheless, larger amounts (in particular >3 g/m²) than in the case of lower grammages are possible without any problems (i.e. in particular without creasing). In one advantageous embodiment, therefore, an amount of wetting agent applied to the web by means of the wetting units per unit of time is adjusted according to a grammage of the paper, wherein, for a higher grammage, the amount is also increased. For the above reason, the relationship is in particular not necessarily linear, and in particular does not necessarily continue up to very high grammages. Analogously, the amount is alternatively or additionally adjusted according to the paper type. This is based on the consideration that the absorption rate, that is to say the ability of the paper to absorb moisture, is also influenced by a binding agent in the paper and optionally further additives, as well as the porosity and initial moisture content of the paper, that is to say generally the type of paper.

Preferably, a maximum of 3 g/m² of wetting agent is applied by each wetting unit. This amount is particularly optimal for typical dimensioning of the plant and for the aforementioned ranges for the minimum dwell time, and is also suitable for typical paper types and grammages. Depending on the grammage, an amount of 1 g/m² to 3 g/m² of wetting agent is preferably applied by a single one of the wetting units, whereby—as already described—a higher amount is also used for a higher grammage. In the case of at least two wetting units, a total of up to 6 g/m² of wetting agent can thus be applied, said wetting agent also being completely absorbed by the paper owing to the multi-stage rewetting process, such that a correspondingly high moisture content is achieved. Specifically for very high grammages (particularly >300 g/m²), or in general, it is expedient for an amount of up to 4, 5 or 6 g/m² or even more to be applied by a single one of the wetting units. The total amount of wetting agent then increases accordingly.

It is suitable if, by means of the wetting units collectively, at least 5 g/m² of wetting agent is applied, or the web is rewetted to at least 4% (i.e. here and elsewhere, wt. %) residual moisture. The wetting units are suitably used to rewet a web of coated paper to at least 4% to 5% residual moisture and/or to rewet a web of uncoated paper to at least 5% to 7% residual moisture. In order to achieve a target water content (equivalent to target residual moisture) by means of the rewetting process and at the end of the plant, a target amount of wetting agent is suitably specified, which is then distributed among the wetting units such that they collectively apply the target amount to the web in a plurality of stages. The residual moisture indicates the amount of moisture in the web relative to the weight of the web. Depending on the grammage, an amount of 5 g/m² to 8 g/m² is preferred, although—as already described—a higher amount is used for a higher grammage. Alternatively or additionally, a residual moisture content in the range from 5% to 6% is preferred, in particular irrespective of the grammage. The drying unit commonly dries the web to a residual moisture content in the range from 2.5% to 3.5% (uncoated paper); accordingly, 1.5% to 3.5% residual moisture is then added by the rewetting process; this is typically not possible with only a single-stage rewetting process. Coated paper generally stores less water, relative to the layer thickness of the paper, than uncoated paper, and is then typically dried out to 1% to 1.5% (from an initial moisture content of 5%), such that 2.5% to 4% residual moisture is then added by the rewetting process in order to achieve a moisture content of 4% to 5%.

The wetting units preferably are each designed as spray bars. These are distinguished in particular by a particularly small installation space requirement and high economic efficiency. In addition, spray bars are advantageously not operated in circulation mode, such that always only fresh wetting agent is applied to the web. In principle, other designs are also conceivable, for example wetting units having rollers or spray plates, although the latter in particular are less economical than spray bars and also require significantly more installation space. In particular, the installation space requirement is an important aspect in the multi-stage rewetting process as described here, because this requires a wetting unit to be accommodated at at least two different locations within the plant. However, because the plant is generally designed to be as compact as possible and a large number of components are combined in a small space, a multi-stage rewetting process using large wetting units (for example spray plates) is not readily possible. Particularly in the case of existing plant designs, retrofitting is then not possible without fundamentally redesigning the plant. By contrast, spray bars are particularly compact and can easily be retrofitted at various points even in existing plants, without the need to abandon the previous plant design.

The use of spray bars also has the advantage that they typically have a plurality of spray nozzles arranged along the width of the web, such that it is also possible to easily compensate, that is to say homogenize, an inhomogeneous moisture profile by selectively controlling individual spray nozzles, for example by activating and deactivating same or by adjusting the amount of wetting agent discharged.

There is a plurality of suitable embodiments for the arrangement of the wetting units within the plant, of which some particularly preferred embodiments are described below. In principle, these embodiments can also be combined with one another.

The plant has at least one plant section which contains the aforementioned processing unit and the drying unit. Depending on the embodiment, however, the plant may under some circumstances also have yet further plant sections through which the web is guided in succession; that is to say, at the end of one plant section, the web is passed on directly to a downstream plant section, such that a plurality of processing operations and/or general treatments can be performed on the web. A final plant section is preferably a winder, by means of which the web is finally wound up to form a roll, or a transfer line, via which the web is transferred directly to a downstream plant without being wound up.

In one suitable embodiment, the wetting units are arranged downstream of a cooling unit of the plant, said cooling unit being arranged downstream of the drying unit. The cooling unit is used, downstream of the drying unit, to cool the web again. The wetting units are now not integrated into this cooling unit, but are arranged separately therefrom and at a different location, in particular further downstream of the cooling unit.

In a further suitable embodiment, the web is not dried or in particular processed between the first and the second wetting unit, instead the web is merely conveyed therebetween. There is therefore no further processing unit or drying unit arranged between the first and the second wetting unit, and merely an absorption of the wetting agent into the paper takes place here. If the plant has a plurality of plant sections, the first and the second wetting unit are accordingly arranged between two plant sections, or at the beginning or end of one plant section, or a combination of these. The first and the second wetting unit and the minimum distance between them are collectively referred to as a two-stage wetting section.

In a further suitable embodiment, the plant comprises a plurality of plant sections, each having a processing unit for processing the web and a downstream drying unit for drying the web, and at least one of the wetting units is arranged downstream of each drying unit, such that the web is wetted at least once after each drying process and in particular before the next drying process or before the end of the plant. By contrast to the two-stage wetting section, the wetting units are now distributed throughout the plant, and are not arranged contiguously. This is based on the consideration that it is typically not detrimental if a drying process takes place between two wetting units, provided that, overall, the desired target residual moisture is achieved at the end of the plant. A wetting process between two drying processes also advantageously prevents the described hornification of the paper, such that, even if a distance between two wetting units and any interposed drying unit is long compared to the minimum distance, an increased absorption rate, established by the wetting unit further upstream, is present at the wetting unit situated further downstream.

In a preferred embodiment, the plant is a printing machine, in particular a digital printing machine. Additionally or alternatively, the processing unit is suitably a printing unit for printing the web with an ink, preferably a water-based ink and/or inkjet ink. In the case of a digital printing machine, the printing unit typically has a plurality of printing bars, in particular for different colors (for example CMYK). In the case of a printing machine, the drying unit is then a print drying unit for drying the ink. The multi-stage rewetting process described here is particularly suitable for use in a printing machine, because in this case the web is generally dried thoroughly in order to dry a print created during the printing with the ink. As a side effect of this, moisture is also removed from the paper, which moisture is then added back by the rewetting process.

In one suitable embodiment, the plant has a primer application unit and a primer drying unit upstream of the printing unit and has a varnish application unit and a varnish drying unit downstream of the printing unit. The primer application unit processes the web in such a way that a primer is applied, which serves in particular as a basis for the subsequently applied print. The primer drying unit dries the applied primer. Analogously, the varnish application unit processes the web in such a way that a varnish is applied, which serves in particular as a finish for the previously applied print. The varnish drying unit dries the applied varnish. The varnish application unit is either analog, that is to say the varnish is applied or sprayed on using a roller or a bath, or digital, that is to say the varnish is printed on by means of one or more printing bars, as in the case with a digital printing unit. The primer application unit and the varnish application unit are further processing units of the plant.

It is expediently the case that two of the wetting units, or alternatively only one of the wetting units, are/is arranged between the primer drying unit and the printing unit. Alternatively or additionally, another of the wetting units, or alternatively even two of the wetting units, is/are suitably arranged between the print drying unit and the varnish application unit. Alternatively or additionally, two more of the wetting units, or alternatively only one of the wetting units, are/is preferably arranged downstream of the varnish drying unit. In one particularly preferred embodiment, the plant has five wetting units, of which two of the wetting units are then arranged between the primer drying unit and the printing unit, another of the wetting units is arranged between the print drying unit and the varnish application unit, and two more of the wetting units are arranged downstream of the varnish drying unit. Which of these wetting units is then the aforementioned first and the second wetting unit is basically arbitrary; this is expediently set according to the specific operating mode and particularly according to the paper type and grammage. In principle, it is advantageous if the two wetting units between the primer drying unit and the printing unit are a first and a second wetting unit for the pre-wetting and post-wetting processes as described, and/or if the two wetting units downstream of the varnish drying unit are a first and a second wetting unit for the pre-wetting and post-wetting processes as described. An advantageous multi-stage rewetting process, in particular a two-stage wetting section, is then realized at the corresponding point before the web is processed in the downstream processing unit or before the web is wound up at the end of the plant or transferred to a downstream plant.

If the web is not wound up at the end of the plant but is transferred to a downstream plant, for example a corrugated cardboard plant, by means of a transfer line, then a further, in particular sixth, wetting unit is expediently arranged along the transfer line. The transfer line and the further wetting unit are then in particular still parts of the plant.

The operation of each wetting unit is not necessarily linked to the operation of the processing unit situated upstream thereof; rather, in one suitable embodiment, wetting is performed irrespective of whether or not processing has been performed upstream. This is advantageous in particular if the drying unit upstream of the wetting unit is active or if it continues to have a follow-on action during a job changeover even though the associated processing unit is inactive, because then the web continues to be dried and rewetting correspondingly remains advantageous. For example, the primer application unit is not required and activated for every job, such that it may be inactive at certain times. In these cases, however, the primer drying unit remains active and dries the web, which is then expediently rewetted by one or more subsequent wetting units before or as the web enters the printing unit.

In one suitable embodiment, the plant has an analog varnish application unit downstream of the printing unit and additionally has a digital varnish application unit downstream of the analog varnish application unit. Optionally, the plant has a primer application unit and a primer drying unit upstream of the printing unit, as already described above. The statements made further above apply to the analog and the digital varnish application unit. In particular, the plant additionally has, downstream of each varnish application unit, an associated varnish drying unit by means of which the varnish applied in each case is dried. Preferably, one of the wetting units is arranged between the printing unit and the analog varnish application unit (and downstream of the print drying unit). Another of the wetting units is arranged between the analog varnish application unit and the digital varnish application unit (and downstream of the varnish drying unit for the analog varnish application unit). Yet another of the wetting units is arranged downstream of the digital varnish application unit (more specifically, even downstream of the varnish drying unit for the digital varnish application unit). The plant thus has a total of three wetting units. Which of these wetting units is then the aforementioned first and the second wetting unit is basically arbitrary; this is expediently set according to the specific operating mode and particularly according to the paper type and grammage. Using all three wetting units together is also advantageous. Alternatively, one of the three aforementioned wetting units is omitted, such that the plant then has only two wetting units, which is already advantageous in itself.

In principle, it is expedient to accommodate in each case one wetting unit at as many locations as possible in order to thus prevent excessive shrinkage of the web within the plant and maintain the dimensional stability of the web over the greatest possible distances within the plant; the one or more processing operations then benefit accordingly from this.

The plant according to the invention is used for processing a web made from paper. The plant comprises a processing unit for processing the web and comprises a drying unit, arranged downstream of the processing unit, for drying the web. The plant furthermore comprises a plurality of wetting units which are arranged downstream of the drying unit and which are designed to rewet the web in multiple stages using a wetting agent, by pre-wetting of the web taking place by way of a first one of the wetting units, and post-wetting of the web taking place after a minimum dwell time by way of a second one of the wetting units. Here, the minimum dwell time is selected in such a way that the web has an increased absorption rate for the wetting agent in the second wetting unit on account of the pre-wetting. The statements made above also apply analogously to the plant.

In the following, exemplary embodiments of the invention will be explained with reference to a drawing. The drawing shows schematically:

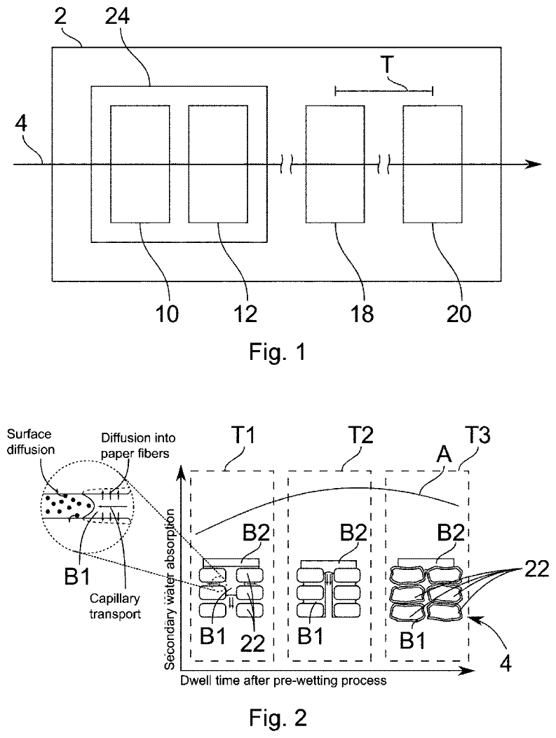

FIG. 1 a plant,

FIG. 2 the absorption of water into paper,

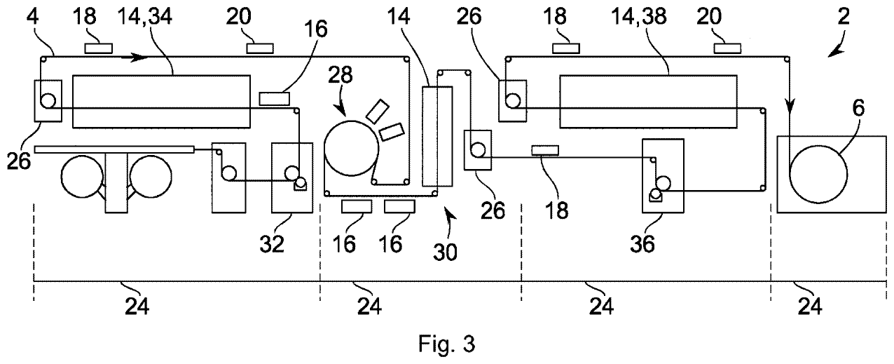

FIG. 3 a variant of the plant from FIG. 1, and

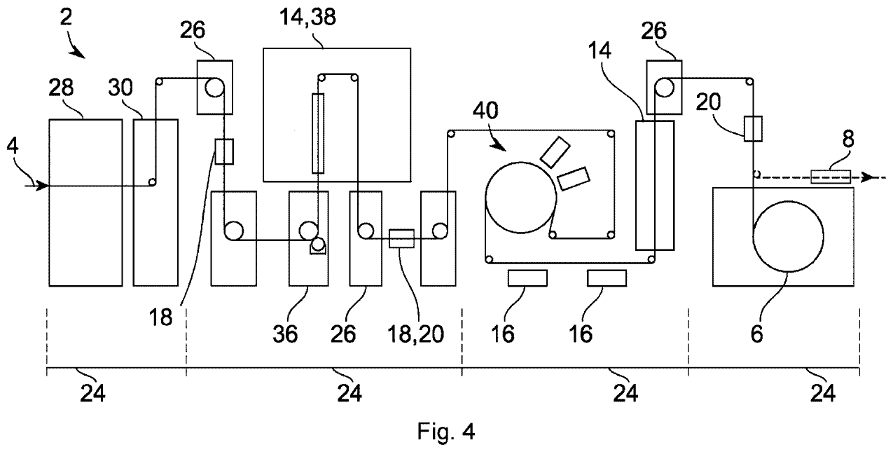

FIG. 4 another variant of the plant from FIG. 1.

FIGS. 1, 3 and 4 each show a variant of a plant 2 for processing a web 4 made from paper. Specifically in FIGS. 3 and 4, without any loss of generality, a digital printing machine is assumed as a plant 2, in which a single-layer web 4 made from paper is printed. However, the statements made in this context also apply analogously to other plants 2, for example a corrugated cardboard plant, and other webs 4, for example multi-layer webs 4 made from paper.

The web 4 is guided through the plant 2 and, for example, unrolled by an unwinder (not explicitly shown) of the plant 2, then processed, and finally rolled up again by a winder 6 of the plant 2, or alternatively passed on directly to a downstream plant (not shown) via a transfer path 8.

The plant 2 generally comprises a processing unit 10 by which the web 4 is processed. Furthermore, downstream of the processing unit 10, the plant 2 has a drying unit 12 for drying the web 4. For drying purposes, the drying unit 12 has one or more hot-air dryers 14 and/or infrared dryers 16. As a matter of principle, moisture is removed from the paper of the web 4 during the drying process, which moisture is to be as completely as possible added back by way of a rewetting process. For this purpose, downstream of the drying unit 12, the plant 2 comprises a plurality of wetting units 18, 20, by means of which the web 4 is rewetted in multiple stages using a wetting agent. In the present case, the web 4 is rewetted in multiple stages using the wetting agent, by pre-wetting taking place by way of a first wetting unit 18, and post-wetting taking place after a minimum dwell time T by way of a second wetting unit 20.

The wetting agent in this case contains predominantly water, and is also a mixture of water and a wetting additive for reducing the surface tension of the water. The wetting agent is optionally additionally mixed with air or similar.

The minimum dwell time T is selected in such a way that the web 4 has an increased absorption rate for the wetting agent in the second wetting unit 20 on account of the pre-wetting. This utilizes the knowledge that, during the pre-wetting process, the wetting agent initially forms a liquid film on the web 4, which liquid film, owing to the preceding drying process, is not immediately completely absorbed into the paper but at least partially remains in situ, and in any case requires a certain amount of time to be completely absorbed by the paper. During this time, the web 4 is flooded with the wetting agent, so to speak, and a further supply of wetting agent is pointless because it cannot be absorbed into the paper. This is illustrated in FIG. 2, which shows the absorption of the wetting agent into the web 4 at different times T1, T2, T3. The wetting agent applied by the pre-wetting process B1, on the one hand, and the wetting agent applied by the post-wetting process B2, on the other hand, are marked differently. Also shown is the absorption capacity A of the paper in the case of post-wetting at the different times T1, T2, T3 (this absorption capacity is a measure of the absorption rate). At time T1 immediately after the pre-wetting process, the liquid film forms a corresponding barrier and limits the maximum absorption capacity of the paper. The paper fibers 22 form a pore structure which is flooded with the wetting agent from the pre-wetting process B1, which makes a post-wetting process more difficult. The enlarged view in FIG. 2 at the time T1 shows in detail the movement of water molecules through the pore structure by capillary transport and the subsequent diffusion into the paper fibers 22. At the time T2, the wetting agent from the pre-wetting process has been completely absorbed into the paper, the pore structure has been pre-wetted and the liquid film has been depleted, the contact angle is in particular 0, and the absorption rate has been increased in relation to the time T1 and also in relation to the absorption rate before the pre-wetting process. At the time T3, the absorption rate remains increased; owing to swelling of the paper fibers 22, the pore structure has closed somewhat and the absorption capacity is not again slightly down.

Accordingly, in the present case, the rewetting process is divided into a plurality of stages, specifically is divided among at least two wetting units 18, 20, which then correspondingly form a first and a second stage of the rewetting process. The pre-wetting process is carried out here not with the actual target amount of wetting agent, but with a reduced amount of wetting agent in relation thereto. Additional wetting agent is then only added during the post-wetting process. Here, because the web 4 has been pre-wetted, the wetting agent from the second wetting unit 20 is absorbed into the paper much faster than without pre-wetting, such that, in total and over the same distance, more wetting agent is introduced into the web 4 than with only single-stage rewetting.

The minimum dwell time T serves for implementing a delay until the most favorable time possible for the post-wetting process. As long as a liquid film is present on the web 4, the absorption rate for further applied wetting agent is practically zero, said absorption rate increasing only once the liquid film has been absorbed by the web 4. Therefore, the minimum dwell time T is selected such that the wetting agent applied by the first wetting unit 18 has been completely absorbed into the web 4 (i.e. at the times T2 and T3 in FIG. 2) when the web 4 reaches the second wetting unit 20. It is particularly here that an absorption rate is increased.

In the present case, an increased absorption rate is initially established in a first stage by means of the pre-wetting process. Only when the absorption rate has been significantly increased, ideally when a suitable threshold value for the absorption rate has been reached, is further moisture introduced into the paper in a second stage by means of the post-wetting process, such that overall more moisture is introduced into the paper in the same period of time and over the same distance.

The minimum dwell time T is, for example, in the range from 0.5 s to 30 s. The minimum dwell time T is equivalent to a minimum distance that the web 4 travels between the first and the second wetting unit 18, 20. The conversion between minimum dwell time T and minimum distance is performed using the web speed, that is to say the speed at which the web 4 is conveyed through the plant 2.

The amount of moisture that the paper can absorb typically depends on the grammage (for example in the range from 100 g/m² to 300 g/m²) of the paper, and generally also on the type of paper. The higher the grammage, that is to say the heavier the paper, the more moisture the paper can absorb. Therefore, for example, an amount of wetting agent applied to the web by means of the wetting units 18, 20 per unit of time is adjusted according to a grammage of the paper, wherein, for a higher grammage, the amount is also increased. Analogously, the amount is alternatively or additionally adjusted according to the paper type.

in the exemplary embodiments shown here, a maximum of 3 g/m² of wetting agent is applied by each wetting unit 18, 20. Depending on the grammage, an amount of 1 g/m² to 3 g/m² or more of wetting agent is applied by a single one of the wetting units 18, 20. It is for example also the case here that, by means of the wetting units 18, 20 collectively, at least 5 g/m² of wetting agent is applied, or the web 4 is rewetted to at least 4% up to at least 7% (i.e. wt. %) residual moisture, in particular depending on whether the paper is coated or uncoated.

In the exemplary embodiments of FIGS. 3 and 4, the wetting units 18, 20 are each designed as spray bars. In principle, other embodiments are also conceivable, for example wetting units with rollers or spray plates.

There is a plurality of suitable embodiments for the arrangement of the wetting units 18, 20 within the plant 2, two of which are shown in FIGS. 3 and 4. Individual aspects of these embodiments can in principle be combined with one another as desired.

In general, the plant 2 has at least one plant section 24 which contains the aforementioned processing unit 10 and the drying unit 12. Depending on the embodiment and particularly in FIGS. 3 and 4, however, the plant 2 under some circumstances has yet further plant sections 24 through which the web 4 is guided in succession. Here, the winder 6 and the transfer line 8 are each a final plant section 24. FIG. 4 specifically shows an embodiment in which both a winder 6 and a transfer line 8 are present, from which a selection is then made as required (alternatively or additionally, inline operation is also implemented here).

In FIGS. 3 and 4, the wetting units 18, 20 are each arranged downstream of an associated cooling unit 26 of the plant 2, said cooling unit being arranged downstream of an associated drying unit 12. The cooling unit 26 is used, downstream of the drying unit 12, to cool the web 4 again. The wetting units 18, 20 are now not integrated into this cooling unit 26, but are arranged separately therefrom and at a different location.

Furthermore, it can be seen specifically in FIG. 3 that the web 4 is not dried or processed between some of the wetting units 18, 20, instead the web is merely conveyed therebetween. Accordingly, no further processing unit 10 or drying unit 12 is arranged between the first and the second wetting unit 18, 20. In FIG. 3, the first and the second wetting unit 18, 20 are arranged at the end of a plant section 24, but other positions are possible and also suitable. The first and the second wetting unit 18, 20 and the minimum distance between them are collectively also referred to as a two-stage wetting section; the plant 2 in FIG. 3 accordingly has two such two-stage wetting sections, whereas the plant 2 in FIG. 4 has none.

In FIGS. 3 and 4, the plant 2 comprises a plurality of plant sections 24, each having a processing unit 10 and a downstream drying unit 12, and at least one of the wetting units 18, 20 is arranged downstream of each drying unit 12, such that the web 4 is wetted at least once after each drying process and before the next drying process or before the end of the plant 2. By contrast to the two-stage wetting section, the wetting units 18, 20 are now distributed throughout the plant 2 and are not arranged contiguously; this is the case particularly in FIG. 4, but also applies in principle to FIG. 3, because there, too, a plurality of wetting units 18, 20 is arranged in each case between the drying units 12 and at the end of the plant 2.

In the embodiments shown by way of example in FIGS. 3 and 4, the plant 2 is a digital printing machine and one of the processing units 10 is a printing unit 28 for printing the web 4 with an ink. The associated drying unit 12 is a print drying unit 30 for drying the ink. In FIG. 3, the print drying unit 30 has, by way of example, five infrared dryers 16 and four hot-air dryers 18. The print drying unit 30 is not shown in detail in FIG. 4.

In FIG. 3, the plant 2 has a primer application unit 32 and a primer drying unit 34 upstream of the printing unit 28 and has a varnish application unit 36 and a varnish drying unit 38 downstream of the printing unit 28. The primer application unit 32 and the varnish application unit 36 are further processing units 10 of the plant 2. The primer application unit 32 applies a primer which serves as a basis for the subsequent print and which is dried by the primer drying unit 34. Analogously, the varnish application unit 36 applies a varnish which serves as a finish for the previously applied print and which is dried by the varnish drying unit 38. In FIG. 3, the varnish application unit 36 is analog, that is to say the varnish is applied or sprayed on using a roller or a bath; a digital varnish application unit 40 is alternatively also suitable, i.e., the varnish is printed on by means of one or more printing bars, as in the case of a digital printing unit.

The plant 2 in FIG. 3 has five wetting units 18, 20, wherein two of the wetting units 18, 20 are arranged between the primer drying unit 34 and the printing unit 28, another of the wetting units 18, 20 is arranged between the print drying unit 30 and the varnish application unit 36, and two more of the wetting units 18, 20 are arranged downstream of the varnish drying unit 38. FIG. 3 also indicates an exemplary assignment as regards which of the wetting units 18, 20 is a first and a second wetting unit 18, 20. In principle, however, this assignment is variable. In FIG. 3, the two wetting units 18, 20 between the primer drying unit 32 and the printing unit 28 are then a first and a second wetting unit 18, 20 for the pre-wetting and post-wetting processes as described, and the two wetting units 18, 20 downstream of the varnish drying unit 38 are also a first and a second wetting unit 18, 20 for the pre-wetting process and post-wetting process as described. A multi-stage rewetting process, specifically a two-stage wetting section, is thus realized at the corresponding point before the web 4 is processed in the downstream processing unit 10 or before the web 4 is wound up at the end of the plant 2 or transferred to a downstream plant. If the web 4 is not wound up at the end of the plant 2 but is transferred to a downstream plant, for example a corrugated cardboard plant, by means of a transfer line 8, then a further, sixth wetting unit 18, 20 (not shown here) is optionally also arranged along the transfer line 8.

The plant 2 in FIG. 4 has an analog varnish application unit 36 downstream of the printing unit 28, and additionally has a digital varnish application unit 40 downstream of said analog varnish application unit. One of the wetting units 18, 20 is arranged between the printing unit 28 and the analog varnish application unit 36, and another of the wetting units 18, 20 is arranged between the analog varnish application unit 36 and the digital varnish application unit 40. Yet another of the wetting units 18, 20 is arranged downstream of the digital varnish application unit 40. The plant 2 thus has a total of three wetting units 18, 20; alternatively, one of these three wetting units 18, 20 is omitted, such that the plant 2 then has only two wetting units 18, 20.

### LIST OF REFERENCE SIGNS

2 Plant
4 Web
6 Winder
8 Transfer path
10 Processing unit
12 Drying unit
14 Hot-air dryer
16 Infrared dryer
18 (First) wetting unit
20 (Second) wetting unit
22 Paper fiber
24 Plant section
26 Cooling unit
28 Printing unit (processing unit)
30 Print drying unit (drying unit)
32 Primer application unit (processing unit)
34 Primer drying unit (drying unit)
36 Varnish application unit (analog, processing unit)
38 Varnish drying unit (drying unit)
40 Varnish application unit (digital, processing unit)
A Absorption capacity
B1 Wetting agent that is applied by the pre-wetting process B1
B2 Wetting agent that is applied by the post-wetting process B2
T Minimum dwell time
T1, T2, T3 Time

1. A method for rewetting a web made from paper, the method comprising:
(a) guiding the web through a plant having a processing unit, by way of which the web is processed;
(b) downstream of the processing unit, drying the web in a drying unit of the plant; and
(c) downstream of the drying unit, rewetting the web in multiple stages using a plurality of wetting units and a wetting agent, wherein the rewetting includes—
(i) pre-wetting the web by way of a first one of the wetting units, and
(ii) (ii) post-wetting of the web after a minimum dwell time (T) by way of a second one of the wetting units,
wherein the minimum dwell time (T) is selected in such a way that the web has an increased absorption rate for the wetting agent in the second wetting unit on account of the pre-wetting.

2. The method according to claim 1,
wherein the minimum dwell time (T) is selected such that the wetting agent applied by the first wetting unit has been completely absorbed into the web when the web reaches the second wetting unit.

3. The method according to claim 1,
where the minimum dwell time (T) is in the range from 0.5 s to 30 s.

4. The method according to claim 1,
wherein an amount of wetting agent applied to the web by means of the wetting units per unit of time is adjusted according to a grammage of the paper,
wherein, for a higher grammage, the amount is also increased.

5. The method according to claim 1,
wherein a maximum of 3 g/m² of wetting agent is applied by each wetting unit.

6. The method according to claim 1,
wherein, by means of the wetting units collectively, at least 5 g/m² of wetting agent is applied, or the web is rewetted to at least 4% residual moisture.

7. The method according to claim 1,
wherein the wetting agent is a mixture of water and a wetting additive.

8. The method according to claim 1,
wherein the wetting units are each designed as spray bars.

9. The method according to claim 1,
wherein the wetting units are arranged downstream of a cooling unit which is arranged downstream of the drying unit.

10. The method according claim 1,
wherein no drying of the web takes place between the first and the second wetting units.

11. The method according to claim 1,
wherein the plant comprises a plurality of plant sections, each having a processing unit and a downstream drying unit,
wherein at least one of the wetting units is arranged downstream of each drying unit, such that the web is wetted after each drying process.

12. The method according to claim 1,
wherein the plant is a printing machine, in which the processing unit is a printing unit for printing the web with an ink, and wherein the drying unit is a print drying unit for drying the ink.

13. The method according to claim 12,
wherein the plant has a primer application unit and a primer drying unit upstream of the printing unit and has a varnish application unit and a varnish drying unit downstream of the printing unit,
wherein two of the wetting units are arranged between the primer drying unit and the printing unit,
wherein another of the wetting units is arranged between the print drying unit and the varnish application unit,
wherein two more of the wetting units are arranged downstream of the varnish drying unit.

14. The method according to claim 12,
wherein the plant has an analog varnish application unit downstream of the printing unit (and has a digital varnish application unit downstream of the analog varnish application unit,
wherein one of the wetting units is arranged between the printing unit and the analog varnish application unit,
wherein another of the wetting units is arranged between the analog varnish application unit and the digital varnish application unit,
wherein another of the wetting units is arranged downstream of the digital varnish application unit.

15. A plant for processing a web made from paper, the plant comprising:
a processing unit for processing the web,
a drying unit, arranged downstream of the processing unit, for drying the web, and
a plurality of wetting units which are arranged downstream of the drying unit and which are designed to rewet the web in multiple stages using a wetting agent, by pre-wetting of the web taking place by way of a first one of the wetting units, and post-wetting of the web taking place after a minimum dwell time (T) by way of a second one of the wetting units,
wherein the minimum dwell time (T) is selected in such a way that the web has an increased absorption rate for the wetting agent in the second wetting unit on account of the pre-wetting.
